(19) United States
(12) Patent Application Publication
(10) Pub. No.: US 2014/0152570 A1
(43) Pub. Date: Jun. 5, 2014

(54) ON-SCREEN KEYBOARD DESIGN

(71) Applicant: THOMSON LICENSING, Issy de Moulineaux (FR)

(72) Inventor: Harry Randall SIEFFERT, San Diego, CA (US)

(21) Appl. No.: 13/903,023

(22) Filed: May 28, 2013

Related U.S. Application Data
(60) Provisional application No. 61/719,742, filed on Oct. 29, 2012.

(51) Int. Cl. G06F 3/0488

(52) U.S. Cl. CPC G06F 3/04886
USPC 345/168

(57) ABSTRACT

An on-screen keyboard comprises a matrix array of alphabetic, numeric and call-to-action characters and/or character sets. First and second contiguous ones of the rows and columns include numeric characters arranged in successive order and these first and second contiguous ones of the rows and columns appears differentiated in the display on screen keyboard as compared to others of the rows and columns. A third one of the rows and columns includes call-to-action characters and/or character sets.

### CROSS-REFERENCE TO RELATED APPLICATIONS

This application claims priority under 35 U.S.C. §119(e) to U.S. Provisional Patent Application Ser. No. 61/719,742, filed Oct. 29, 2012, the teachings of which are incorporated herein.

### TECHNICAL FIELD

This invention relates to an on-screen keyboard display.

### BACKGROUND ART

Today, there exist many devices, and especially mobile devices, such as tablets and so-called “smart” phones, that have the capability of displaying a keyboard through which a user can enter information. Typically, the “on-screen” keyboard displayed by such devices includes alphanumeric and special characters and character sets arranged in a particular pattern. A user enters information via the on-screen keyboard by touching various characters and character sets on the screen in sequence to create one or more strings comprised of letters, numbers and/or special characters. Such on-screen keyboards make use of well-known touch screen technology which relies on a change in capacitance occurring in response to the user physically touching the screen in an area associated with a particular character or character set.

Various designs exist for on-screen keyboard. The traditional “QWERTY” keyboard remains the best know design and mirrors the keyboard design of conventional typewriters and computer keyboards. The term “QWERTY” refers the appearance of the letters Q, W, E, R, T and Y appearing in the first row of alphabetic characters on the keyboard.

Other on-screen keyboard designs exist as well. FIG. 1 depicts an on-keyboard design corresponding to the Yahoo TV Widgets Software Defined Keyboard. The keyboard design of FIG. 1 suffers from the following usability issues:

1. The ‘0’ (zero) placement is not sequentially positioned with other number keys.
2. For email input, no “.com” or “.” (period), or “@” exists.
3. Empty keys appear on the symbols keyboard (more an aesthetic issue rather than usability).

Thus, a need exists for an on-screen keyboard not subject to the aforementioned disadvantages.

### BRIEF SUMMARY OF THE INVENTION

Briefly, in accordance with a preferred embodiment of the present principles, an on-screen keyboard comprises a matrix array of alphabetic, numeric and call-to-action characters and/or character sets. First and second contiguous ones of the rows and columns include numeric characters arranged in successive order and these first and second contiguous ones of the rows and columns appears differentiated in the display on screen keyboard as compared to others of the rows and columns. A third one of the rows and columns includes call-to-action characters and/or character sets.

### BRIEF SUMMARY OF THE DRAWINGS

FIG. 1 depicts an on-screen keyboard according to the prior art:

FIGS. 2A, 2B and 2C exemplary on-screen keyboards in accordance with the present principles

FIGS. 3A-3E depicts additional exemplary on-screen keyboards in accordance with the present principles; and

FIG. 4 depicts a block schematic diagram of an exemplary apparatus for displaying the on-screen keyboards of FIGS. 2 and 3A-3E.

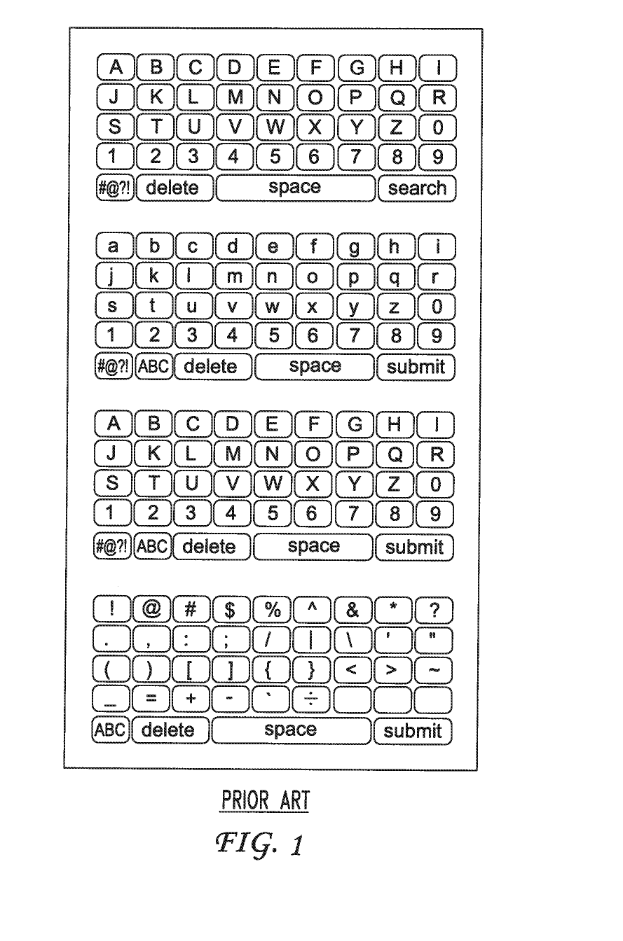

### DETAILED DESCRIPTION

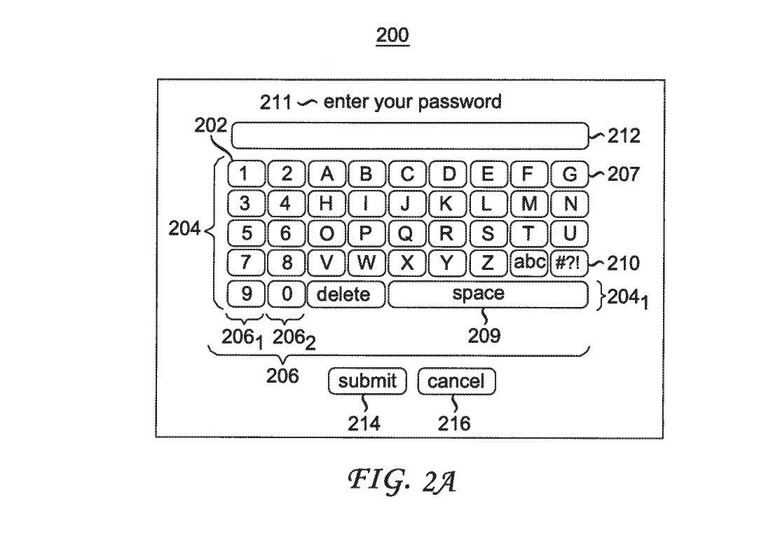

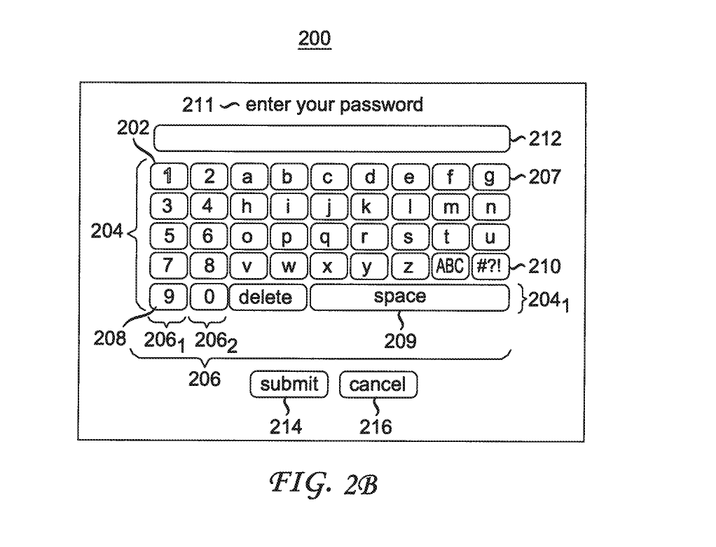

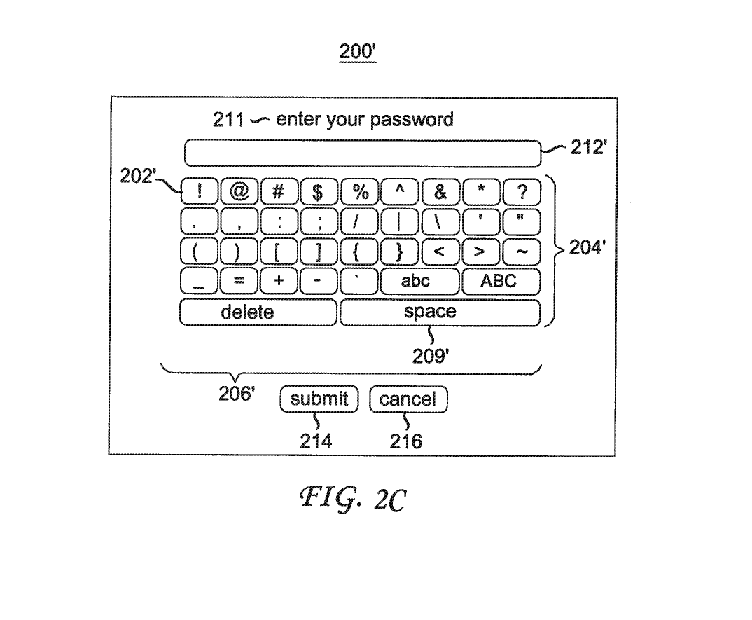

FIG. 2A depicts a display 200 of a first exemplary on-screen keyboard 202 comprised of a matrix array of rows 204 and columns 206 of alphabetic, numeric, call-to-action and/or special characters and/or characters sets. The alphabetic, numeric, call-to-action and/or special characters and/or characters sets are exemplified by alphabetic character 207 (the character “g”), numeric character 208 (the number “9”), call-to action character 209 (the space bar), and the special character 210 (the secondary character display key), respectively. The on-screen keyboard 202 can have an arbitrary size, e.g., M rows 204×N columns 206 where M and N constitute integers. As depicted in FIG. 2, one or more of the characters, such as for example, the call-to action character set 209, can overlap two columns. Although not shown one or more characters/character sets could overlap two or more rows.

The on-screen keyboard 202 of FIG. 2 includes at least two contiguous columns, for example 206₁ and 206₂ that comprise mostly if not all numeric characters, including numeric character 208. In the illustrated embodiment of FIG. 2, the column 206₁ in the on-screen keyboard 202 comprises odd numbers (e.g., 1, 3, 5, 7 and 9) with the numeric characters increasing in succession from the top (number “1”) to the bottom of the column (the number “9”). Conversely, the column 206₂ comprises even numbers (2, 4, 6, 8 and 0), with the numeric characters arranged in successive order, beginning with the number “2” at the top of the column and ending with the number “0” at the bottom.

The numeric characters appearing in columns 206₁ and 206₂ of the on-screen keyboard 202 of FIG. 2 could have other arrangements. For example, column 206₁ could include the numeric characters “1, 2, 3, 4, and 5” in succession with the numeric character “1” appearing either at the top or bottom of the column. Under such circumstances, the column 206₂ would include the numeric characters “6, 7, 8, 9 and 0” in succession, with the number “6” appearing either at the top or bottom of that column.

In accordance with one aspect of the present principles, the columns 206₁ and 206₂ appear differentiated from the other columns upon display of the on-screen keyboard 202. To reflect that differentiation, the columns 206₁ and 206₂ appear shaded in the display 200 of FIG. 2 relative other columns comprising the on-screen keyboard 202. Various display techniques could serve to differentiate columns 206₁ and 206₂ from the other columns upon display of the on-screen keyboard 202. For example, when the display 200 constitutes a color display, the columns 206₁ and 206₂ could appear in different colors from the other columns in the onscreen-keyboard to differentiate these columns containing the numeric characters. Further, the columns 206₁ and 206₂ could have a different brightness (e.g., brighter or darker) as compared to the other columns in the on-screen keyboard 202.

As depicted in FIG. 2A, the columns 206₁ and 206₂, which lie contiguous to each other, typically appear adjacent to the left side of the on-screen keyboard 202. Although not shown, the columns 206₁ and 206₂ that include the numeric characters could appear adjacent to the right side of the on-screen keyboard 202 of FIG. 2A. Rather than arrange the numeric characters in two contiguous columns, the numeric characters could appear in two contiguous rows differentiated from the other rows using one of the mechanisms discussed previously for differentiating the columns 206₁ and 206₂.

As discussed above, the on-screen keyboard 202 of FIG. 2B includes one or more call-to-action characters and/or character sets, exemplified by the character set 209 (the “space” bar). Another call-to -action character set could include the “delete” character set. These two call-to-action characters sets initiate well-known functions. The on-screen keyboard 202 of FIG. 2A can include other call-to-action character sets, which when actuated by a user, accomplish selected functions. For example, an exemplary call-to-action character set could comprise the “submit” charter set which a user would actuate to initiate processing of a string of previously entered characters. Yet another call-to-action action character set could comprise the “search” call-to-action character set which a user would actuate to initiate a search of a previously entered string of characters. A further call-to-action character set could include the character set “.com” which a user could enter as part of an e-mail address to reduce the need to enter these characters individually. The above-described call-to-action character sets represent merely examples and other call-to-action character sets could easily find application in the on-screen keyboard 202 of FIG. 2A in place of or in addition to the call-to-action character sets thus far described without departing from the present principles. Indeed, the keyboard of the present principles could include a user-programmable call-to-action character set. Typically, a majority if not all of the call-to action characters appearing in the on-screen keyboard 202 lie in a single row, e.g., row 204₁ appearing at the bottom of the on-screen keyboard.

Referring to FIG. 2A, in addition to the on-screen keyboard 202, the display 200 can also include a display message 211 directing the user to enter information via the on-screen keyboard. In addition, the display 200 can include a display screen area 212 for displaying information entered through the on-screen keyboard 202. Lastly, the display 200 can also include touch pad areas, such as areas 214 and 216, separate from the on-screen keyboard 202 to allow a user to enter functional commands, for example “submit” and “cancel” commands to submit and cancel, respectively, a string of characters and/or character sets.

FIG. 2B depicts an on-screen keyboard 202 identical to the on-screen keyboard 202 of FIG. 2A except that the alphabetic characters, such as the alphabetic character 207, all appear in lower case. In contrast, the alphabetic characters in the on-screen keyboard 202 of FIG. 2A appear in upper case.

As discussed above, the on-screen keyboards 202 of FIGS. 2A and 2B can also include one or more special characters, such as the secondary character display key 210. Actuation of the secondary character display key 210 triggers the display of a secondary on-screen keyboard with different characters, as depicted by the on-screen keyboard 202′ depicted in FIG. 2C comprised of a matrix array of rows 204′ and columns 206′ as well as one or more character sets 209′ (e.g., the space bar). For example, the secondary on-screen keyboard 202′ of FIG. 2C displayed following actuation of the secondary character display key 210 in the keyboard 202 of FIGS. 2A and 2B could include punctuation characters, for example “?”, “!” “:”, and “;”. In addition to, or in place of the punctuation characters, the secondary on-screen keyboard 202′ of FIG. 2C could include mathematical symbols such as “+”, and “=” for example. Other special characters could include “©” and “®”. The special characters thus far described constitute merely examples and the secondary on-screen keyboard could include many other special characters without departing from the present principles.

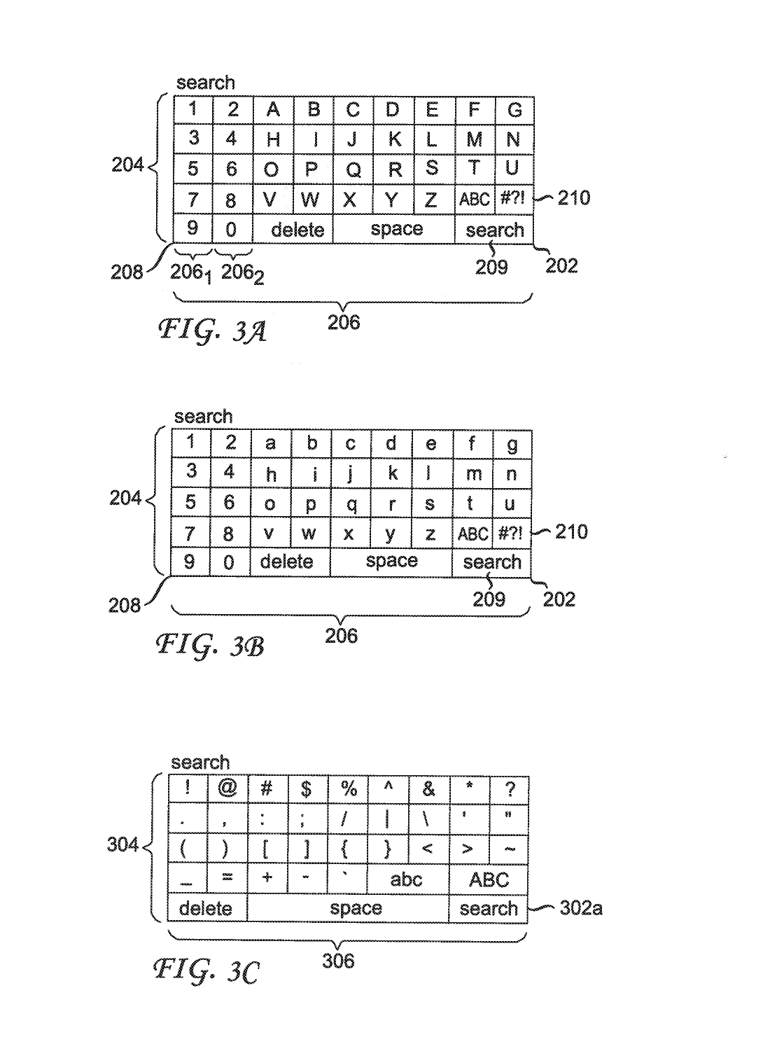

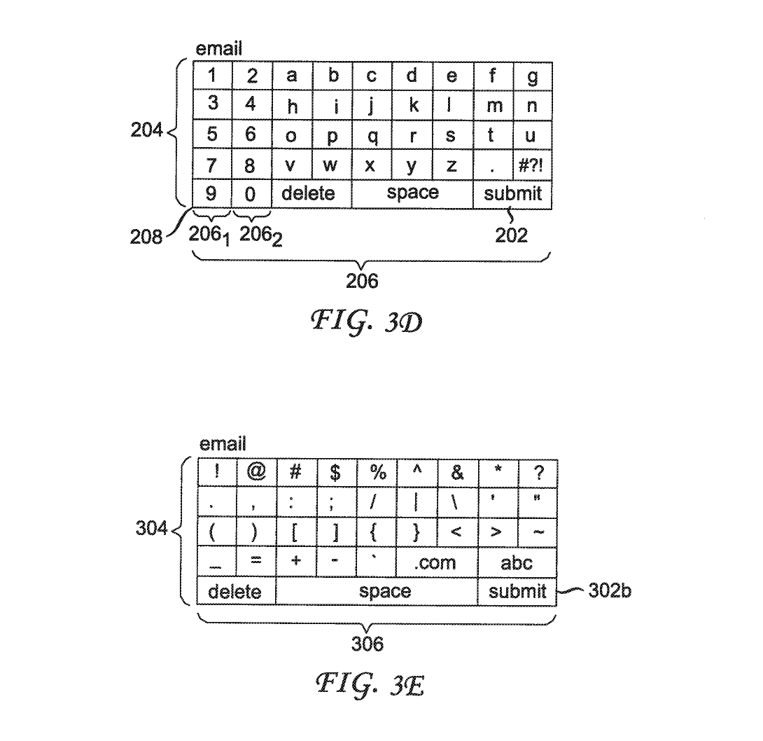

FIGS. 3A-3E depict different variations of the on-screen keyboard 202 depicted in FIGS. 2A and 2B. Like the on-screen keyboard 202 of FIGS. 2A and 2B, the on-screen keyboard 202 of FIG. 3A comprises a matrix array of rows 204 and columns 206, with the columns 206₁ and 206₂ including mostly if not exclusively, numeric characters. As with the on-screen keyboard 202 of FIGS. 2A and 2B, the columns 206₁ and 206₂ of the on-screen keyboard 202 of FIG. 3A appear differentiated from the other columns in the matrix array, as indicated by the shading applied to these columns. As with the on-screen keyboard 202 of FIGS. 2A and 2B, the remaining columns in the on-screen keyboard 202 of FIG. 3A (i.e., the columns other than columns 206₁ and 206₂) include alphabetic, call-to-action and special characters and/or character sets. Further, like the on-screen keyboard 202 of FIGS. 2A and 2B, the last row in the on screen keyboard 202 of FIG. 3A includes most if not all of the call-to action characters and/or character sets. Like the on-screen keyboard 202 of FIG. 2A, the alphanumeric characters in the on-screen keyboard 202 of FIG. 3A appear in upper case.

The on-screen keyboard 202 of FIG. 3A has particular applicability for enabling a user to undertake searching. To that end, the on-screen keyboard 202 of FIG. 3A includes the character set “search” as one of the call-to-action character sets appearing in the last row of the on-screen keyboard. After entering a search string, the user would then actuate the “search” call-to-action character set in on-screen keyboard 202 of FIG. 3A to launch the desired search.

FIG. 3B depicts an on-screen keyboard 202 similar to the on-screen keyboard 202 of FIG. 3A. As compared to the on-screen keyboard 202 of FIG. 3A, the on-screen keyboard 202 of FIG. 3B has its alphabetic characters in lower case, just like the on-screen keyboard 202 of FIG. 2B.

FIG. 3C depicts a secondary on-screen keyboard 302a which will display after a user actuates the special character key 210 (i.e., the secondary character display key) in one of on-screen keyboards 202 of FIGS. 2, 3A and 3B. The secondary on-screen keyboard 302a of FIG. 3C primarily comprises special characters, for example, punctuation marks as well as mathematical operators. The secondary on-screen keyboard 302a of FIG. 3C could include other special characters as well.

FIG. 3D depicts another exemplary on-screen keyboard 202 similar to the on-screen keyboard 202 of FIG. 3B. However, the on-screen keyboard 202 of FIG. 3D has particular applicability for e-mail communications, rather than searching. Thus, the on-screen keyboard 202 of FIG. 3D includes various call-to action character sets in the last row of the keyboard, such as “@”, “.com” and “submit” useful in creating e-mail messages. (By comparison, the on-screen keyboard 202 of FIGS. 3A and 3C include call-to action character sets such as “search” which have applicability for searching.)

Lastly, FIG. 3E depicts a secondary on-screen keyboard 302b which will display after a user actuates the special character key 210 (i.e., the secondary character display key) in one of on-screen keyboard 202 of FIG. 3D. The secondary on-screen keyboard 302b of FIG. 3E primarily comprises special characters, for example, punctuation marks as well as mathematical operators. The secondary on-screen keyboard 302b of FIG. 3E could include other special characters as well.

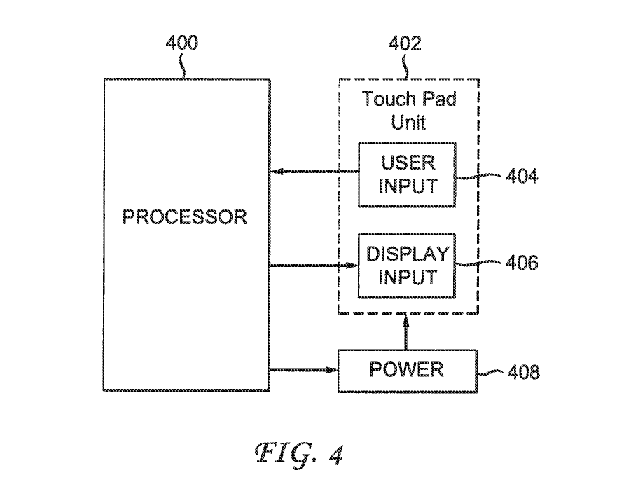

FIG. 4 depicts an exemplary mechanism effecting display of the on-screen keyboards of FIGS. 2 and 3A-3E of the present principles. The mechanism of FIG. 4 includes a processor 400, typically a microprocessor, coupled to a touch pad unit 402 that includes a user input device 404 and a display device 406. The display device 406 typically comprises an LCD or OLED screen, whereas the user input device 404 comprises a set of touch pads (electrodes) integrated with the display unit so that when the user touches the screen of the display device, the input device can detect that touch though a change in capacitance. The processor 400 includes programmed instructions stored in a memory integral with or separate from the processor for causing the display device 406 to physically display the on-screen keyboard of the present principles, and for detecting user actuation of the alphabetic, numeric, call-to-action and/or special characters and/or character sets of the on-screen keyboard.

The foregoing describes an on-screen keyboard.

1. An on-screen keyboard, comprising:
a matrix array that includes alphabetic, numeric and call-to-action characters and/or character sets,
wherein first and second contiguous ones of the rows or columns includes numeric characters arranged in successive order;
wherein the first and second contiguous ones of the rows or columns appear differentiated relative to others of the rows or columns; and
wherein a third one of the rows or columns includes the call-to-action characters.

2. The on-screen keyboard according to claim 1 further including at least one special character.

3. The on-screen keyboard according to claim 2 wherein the special character comprises a secondary keyboard display character, which when actuated, triggers display of a secondary on-screen keyboard.

4. The on-screen keyboard according to claim 1 wherein at least one of the call-to action characters and/or character sets has specific application for e-mail communications.

5. The on-screen keyboard according to claim 4 wherein the at least one call-to action characters and/or character set comprises the character set “.com.”

6. The on-screen keyboard according to claim 4 wherein the at least one call-to action characters and/or character set comprises the character “@.”

7. The on-screen keyboard according to claim 4 wherein the at least one call-to action character set comprises the character set “submit.”

8. The on-screen keyboard display according to claim 1 wherein at least one of the call-to action characters and/or character sets has specific application for searching.

9. The on-screen keyboard according to claim 8 wherein the at least one call-to action character set comprises the character set “submit.”

10. The on-screen keyboard of claim 1 wherein the first and second contiguous ones of the rows or columns are differentiated relative to others of the rows or columns by appearing in different colors.

11. The on-screen keyboard of claim 1 wherein the first and second contiguous ones of the rows or columns are differentiated relative to others of the rows or columns by appearing in different brightness.

12. A method for displaying an on-screen keyboard, comprising the step of:
displaying a matrix array of rows and columns that includes alphabetic, numeric and call-to-action characters and/or character sets,
wherein first and second contiguous ones of the rows or columns includes numeric characters arranged in successive order;
wherein the first and second contiguous ones of the rows or columns appear differentiated relative to others of the rows or columns; and
wherein a third one of the rows or columns includes the call-to-action characters.

13. The method according to claim 12 wherein the matrix array includes further at least one special character.

14. The method according to claim 13 further including the step of displaying a secondary on-screen keyboard in response to actuation of the at least one special character.

15. The method according to claim 12 wherein at least one of the call-to action characters and/or character sets has specific application for e-mail communications.

16. The method according to claim 15 wherein the at least one call-to action characters and/or character set comprises the character set “.com.”

17. The method according to claim 15 wherein the at least one call-to action characters and/or character set comprises the character “@.”

18. The method according to claim 15 wherein the at least one call-to action character set comprises the character set “submit.”

19. The method according to claim 12 wherein at least one of the call-to action characters and/or character sets has specific application for searching.

20. The method according to claim 19 wherein the at least one call-to action character set comprises the character set “submit.”

21. The method according to claim 12 wherein the first and second contiguous ones of the rows or columns are differentiated relative to others of the rows or columns by appearing in different colors.

22. The method according to claim 12 wherein the first and second contiguous ones of the rows or columns are differentiated relative to others of the rows or columns by appearing in different brightness.
